(19) United States
(12) Patent Application Publication
(10) Pub. No.: US 2020/0052535 A1
(43) Pub. Date: Feb. 13, 2020

(54) MOTOR AND PUMP DEVICE

(71) Applicant: NIDEC SANKYO CORPORATION, Nagano (JP)

(72) Inventors: Masaki HARADA, Nagano (JP); Hiroki KURATANI, Nagano (JP)

(21) Appl. No.: 16/483,816

(22) PCT Filed: Feb. 8, 2018
(86) PCT No.: PCT/JP2018/004350

§ 371 Date: Aug. 6, 2019

(30) Foreign Application Priority Data
Feb. 14, 2017 (JP) 2017-024961

(51) Int. Cl. H02K 1/30; H02K 5/167

(52) U.S. Cl. CPC H02K 1/30; H02K 5/1677

(57) ABSTRACT

A motor may include a rotor comprising a rotating shaft and a bearing component structured to rotatably support. The bearing component may include a sliding surface that the rotor sliding-contacts from a first side in an axial direction. The rotor may include a holding member structured to hold the rotating shaft from an outer circumferential side; a magnet held by the holding member; and a metal component fixed to the rotating shaft and held by the holding member so as to protrude to the outer circumferential side from the rotating shaft.

### CROSS REFERENCE TO RELATED APPLICATIONS

This is the U.S. national stage of application No. PCT/JP2018/004350, filed on Feb. 8, 2018. Priority under 35 U.S.C. §119(a) and 35 U.S.C. §365(b) is claimed from Japanese Application No. 2017-024961, filed Feb. 14, 2017; the disclosures of which are incorporated herein by reference.

### FIELD OF THE INVENTION

At least an embodiment of the present invention relates to a motor in which a rotor slides on a bearing component that supports a rotating shaft, and also relates to a pump device in which an impeller is driven by the motor.

### BACKGROUND

A pump device provided with an impeller and a motor for driving the impeller is described in Patent Document 1. In the pump device described in the document, the motor includes a rotor and a stator that is shaped cylindrical and placed at an outer circumferential side of the rotor. The rotor is provided with a tubular sleeve, a magnet placed annularly at an outer circumferential side of the sleeve, and a holding member that holds the sleeve and the magnet. In the sleeve, there is inserted a stationary shaft, and the rotor is supported by the stationary shaft so as to be rotatable. At a halfway position in an axial direction of the stationary shaft, there is assembled a bearing component that extends toward an outer circumferential side. The bearing component works as a thrust bearing component for the rotor. The sleeve sliding-contacts the bearing component while sliding on it, from one side in the axial direction.

### PATENT DOCUMENT

Patent Document 1: Japanese Unexamined Patent Application Publication No. 2016-3580

When the rotor rotates, heat is generated between the rotor and the bearing component due to a slide motion. Therefore, in the case where the sleeve and the holding member, which make up the rotor, are made of a resin material, there is a risk that these resin-made components may be deformed owing to the heat generated, in such a way that a position of the rotor may potentially change in the axial direction. If once the position of the rotor changes in the axial direction, a position of the magnet changes in the axial direction so that it becomes impossible to maintain rotation accuracy of the rotor.

### SUMMARY

Then, with the issue described above being taken into consideration, at least an embodiment of the present invention provides a motor with which it is possible to prevent the magnet, held by the resin-made holding member in the rotor, from changing its position because of heat generated due to the slide motion between the rotor and the bearing component. Moreover, at least an embodiment of the present invention provides a pump device in which an impeller is turned by use of such a motor.

In order to solve the issue described above, a motor according to at least an embodiment of the present invention comprises: a rotor including a rotating shaft; and a bearing component for supporting the rotating shaft in such a way as to be rotatable; wherein, the bearing component includes a sliding surface that the rotor sliding-contacts from one side in an axial direction; and the rotor includes, a holding member that holds the rotating shaft from an outer circumferential side, a magnet held by the holding member, and a metal component fixed to the rotating shaft so as to protrude to an outer circumferential side from the rotating shaft, and held by the holding member.

According to at least an embodiment of the present invention, the holding member made of a resin material, which holds the rotating shaft from an outer circumferential side, holds the metal component that is fixed to the rotating shaft so as to protrude from the rotating shaft toward an outer circumferential side. Therefore, even in the case where heat is generated due to a slide motion between the bearing component and the rotor, it is possible to prevent or restrain a position of the holding member from changing in relation to the rotating shaft in the axial direction, because the metal component is fixed to the rotating shaft. Accordingly, it is possible to prevent or restrain the magnet, held by the holding member, from changing its position in the axial direction so that the rotation accuracy of the rotor can be maintained. Moreover, since the holding member holds the metal component being fixed to the rotating shaft, the heat generated due to the slide motion between the bearing component and the rotor can be released to a side of the rotating shaft by the intermediary of the metal component. Therefore, it is possible to prevent or restrain the holding member, made of resin, from getting deformed owing to the heat generated due to the slide motion between the bearing component and the rotor.

According to at least an embodiment of the present invention, the rotating shaft is made of metal. Thus, the heat generated due to the slide motion between the rotor and the bearing component is easily released by the intermediary of the rotating shaft.

According to at least an embodiment of the present invention, the rotating shaft includes an annular groove, and the metal component is a stop ring fixed to the annular groove. Thus, it is easy to fix the metal component to the rotating shaft so as to protrude from the rotating shaft toward an outer circumferential side.

According to at least an embodiment of the present invention, the rotor includes a second metal component held by the holding member, the second metal component includes a rotor side sliding surface that sliding-contacts the sliding surface, and the metal component contacts the second metal component from a side opposite to the sliding surface in the axial direction. Thus, since a part that slides against the bearing component is made of metal in the rotor, the part is free from deformation owing to heat generated due to the slide motion. Moreover, the metal component fixed to the rotating shaft contacts the second metal component, from a side opposite to the sliding surface. Therefore, even in the case where a force, biasing the rotor toward a side of the bearing component, acts at a time when the rotor rotates so as to press the second metal component against the bearing component, the second metal component does not change its position so as to move away from the sliding surface in the axial direction, and it is possible to prevent the rotor from changing its position in the axial direction. Furthermore, the metal component contacts the second metal component, and therefore the heat generated due to the slide motion between the bearing component and the rotor can be released from the second metal component to the side of the rotating shaft by the intermediary of the metal component. Moreover, the second metal component is held by the holding member, and not fixed to the rotating shaft. Therefore, it is possible to avoid deformation of the second metal component to be caused by way of fixing to the rotating shaft. Thus, a flatness of the rotor side sliding surface can be maintained in such a way that it becomes easy to obtain the rotation accuracy of the rotor.

According to at least an embodiment of the present invention, the second metal component is an annular component through which the rotating shaft passes; and the holding member includes a contacting part that contacts the second metal component from the side opposite to the sliding surface in the axial direction, and a plastically-deformed part that covers an outer circumferential edge of the second metal component from a side of the sliding surface and an outer circumferential side. Thus, it is easy to hold the second metal component by the holding member.

According to at least an embodiment of the present invention, the second metal component includes a cutout part at an outer circumferential edge. Thus, it is possible, for example, to provide the holding member, made of a resin material, with the plastically-deformed part deformed by heat, in such a way as to make the resin material, being deformed, enter the cutout part at the time of holding the second metal component. Thus, the second metal component can surely be held by the holding member.

Then, a pump device according to at least an embodiment of the present invention comprises the motor described above, and an impeller fixed to the rotating shaft; wherein, the bearing component orients the sliding surface toward a side opposite to the impeller.

According to the invention of the present application, since the impeller is fixed to the rotating shaft of the motor, a force biasing in the axial direction of the rotating shaft toward a side of the impeller acts on the rotor, at a time when the rotor rotates (when the impeller fixed to the rotating shaft rotates). Therefore, heat due to the slide motion is likely to be generated between the bearing component, which orients the sliding surface toward a side opposite to the impeller, and the rotor, so that there is a risk that the holding member, made of resin, gets deformed owing to the heat generated, and the rotor changes its position in the axial direction. Meanwhile, in the motor; the holding member made of resin, which holds the rotating shaft from the outer circumferential side, holds the metal component that is fixed to the rotating shaft so as to protrude from the rotating shaft toward the outer circumferential side. Therefore, even in the case where the holding member gets deformed owing to the heat generated due to the slide motion between the bearing component and the rotor, it is possible to prevent or restrain a position of the holding member from changing in relation to the rotating shaft in the axial direction. Accordingly, it is possible to prevent or restrain the magnet, held by the holding member, from changing its position in the axial direction so that the rotation accuracy of the rotor can be maintained. Then, the rotation accuracy of the impeller can be maintained. Moreover, since the holding member holds the metal component being fixed to the rotating shaft, the heat generated due to the slide motion between the bearing component and the rotor can be released to a side of the rotating shaft by the intermediary of the metal component. Therefore, it is possible to prevent or restrain the holding member, made of resin, from getting deformed owing to the heat generated due to the slide motion between the bearing component and the rotor.

### ADVANTAGEOUS EFFECT OF THE INVENTION

In the motor according to at least an embodiment of the present invention; the holding member, which holds the rotating shaft from an outer circumferential side in the rotor, holds the metal component that is fixed to the rotating shaft and protrudes toward an outer circumferential side from the rotating shaft. Therefore, even in the case where the holding member is deformed owing to heat generated due to the slide motion between the bearing component and the rotor, it is possible to prevent or restrain the position of the holding member from changing in relation to the rotating shaft in the axial direction. Accordingly, it is possible to prevent or restrain the magnet, held by the holding member, from changing its position in the axial direction so that the rotation accuracy of the rotor can be maintained. Moreover, since the holding member holds the metal component being fixed to the rotating shaft, the heat generated due to the slide motion between the bearing component and the rotor can be released to a side of the rotating shaft by the intermediary of the metal component. Therefore, it is possible to prevent or restrain the resin-made holding member from getting deformed owing to the heat generated due to the slide motion between the bearing component and the rotor. Moreover, in the pump device according to at least an embodiment of the present invention; the rotation accuracy of the rotor can be maintained in the motor working as a driving source for the impeller so that the rotation accuracy of the impeller can be maintained.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view of a pump device according to an embodiment of the present invention.

FIG. 2 is a perspective view of a motor of the pump device, in a view observed from a side of protrusion of a rotating shaft.

FIG. 3 is a perspective view of the motor, in a view observed from an opposite side of the protrusion of the rotating shaft.

FIG. 4 is an exploded perspective view of the motor.

FIG. 5 is an exploded perspective view of the motor, wherein a cover member is removed.

FIG. 6A and FIG. 6B includes an exploded perspective view of a rotor, and an explanatory drawing of fixing construction of a stop ring.

FIG. 7 is a perspective view of a stator.

FIG. 8 is a perspective view of the cover member.

### DETAILED DESCRIPTION

With reference to the drawings, a pump device and a motor according to an embodiment of the present invention are explained below.

### Pump Device

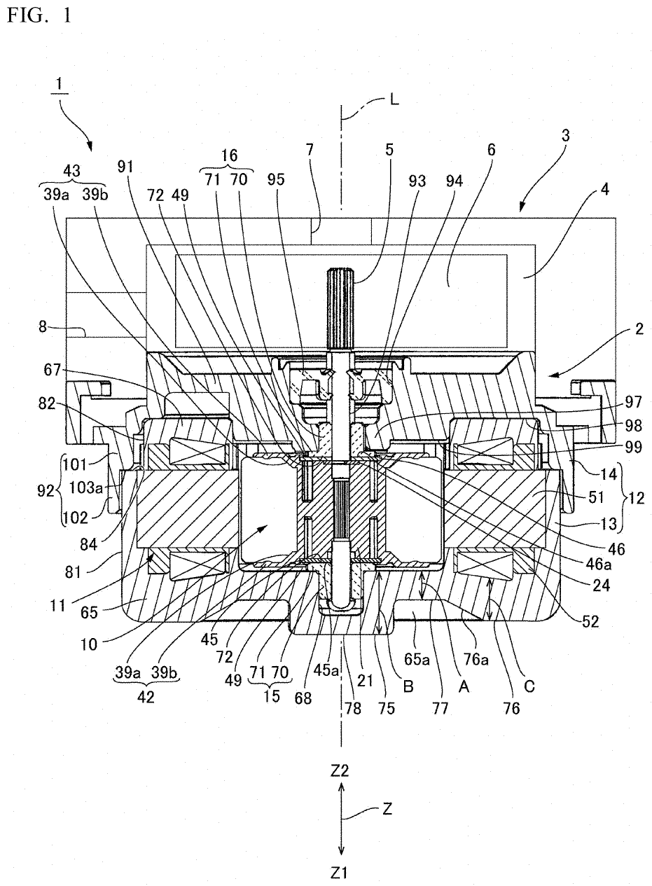

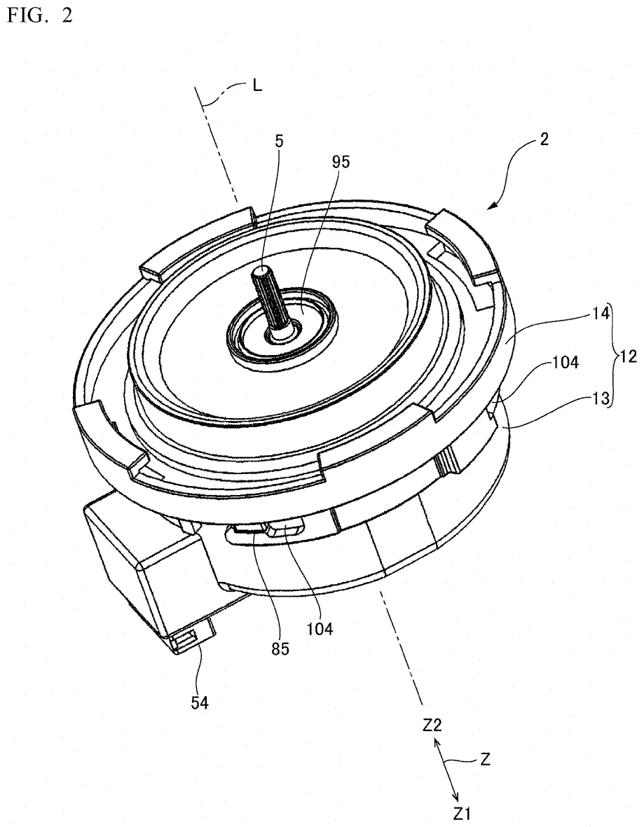

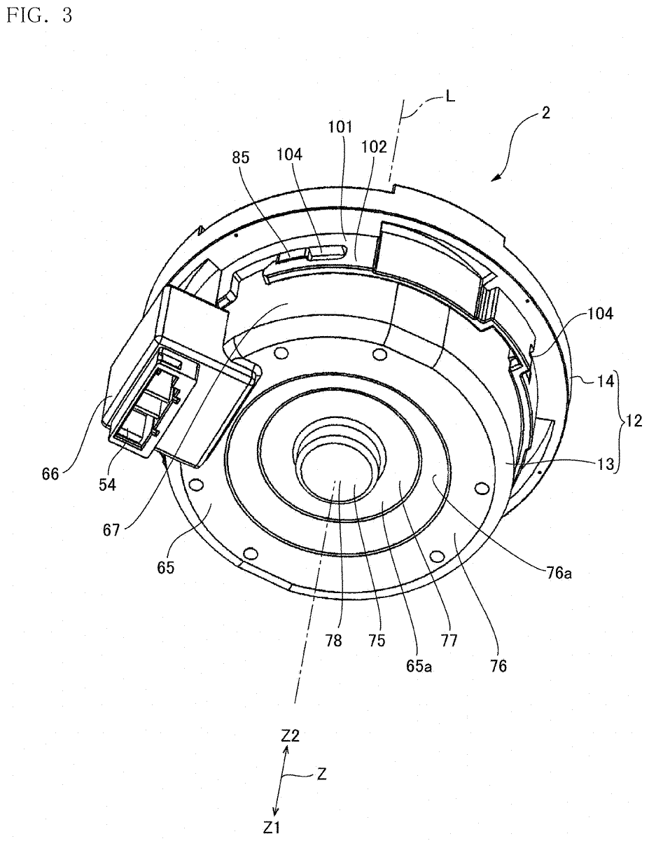

FIG. 1 is a cross-sectional view of a pump device according to the embodiment of the present invention. FIG. 2 is a perspective view of a motor, working as a driving source of the pump device, in a view observed from an output side where a rotating shaft protrudes. FIG. 3 is a perspective view of the motor, working as the driving source of the pump device, in a view observed from a counter-output side that is opposite to the side where the rotating shaft protrudes. As shown in FIG. 1, a pump device 1 includes a motor 2, a case body 3 covering the motor 2, a pumping chamber 4 partitioned between the motor 2 and the case body 3, and an impeller 6 that is mounted on a rotating shaft 5 of the motor 2 and placed inside the pumping chamber 4. In the case body 3, there are provided a suction port 7 and a discharge port 8 of a fluid; and if the motor 2 is driven in order to turn the impeller 6, the fluid such as water, sucked from the suction port 7, is discharged from the discharge port 8 by way of the pumping chamber 4. In the following explanation, for convenience, a direction of an axis line L of the rotating shaft 5 is represented as a vertical direction (a Z-direction). Then, one side in the Z-direction is referred to as a lower side, i.e., a downward direction (a first direction Z1); and meanwhile the other side is referred to as an upper side, i.e., an upward direction (a second direction Z2). The downward direction is a direction that stretched from the pumping chamber 4 toward the motor 2, and the lower side is a counter-output side. Then, the upward direction is a direction in which the rotating shaft 5 protrudes out of the motor 2, and the upper side is an output side. Moreover, a direction perpendicular to the axis line L is represented as a radial direction, and a direction circling around the axis line L is referred to as a circumferential direction.

The motor 2 is a DC brushless motor; including a rotor 10, a stator 11, and a housing 12 which stores the rotor 10 and the stator 11. As shown in FIG. 2 and FIG. 3, the housing 12 is provided with a resin sealing member 13 that covers the stator 11 from a lower side, and a cover member 14 that covers the resin-made sealing member 13 from an upper side. In the resin-made sealing member 13, there is held a first bearing component 15 that supports a lower side part of the rotating shaft 5 in such a way as to be rotatable. In the cover member 14, there is held a second bearing component 16 that supports a middle part of the rotating shaft 5 of the rotor 10 in such a way as to be rotatable.

### Rotor

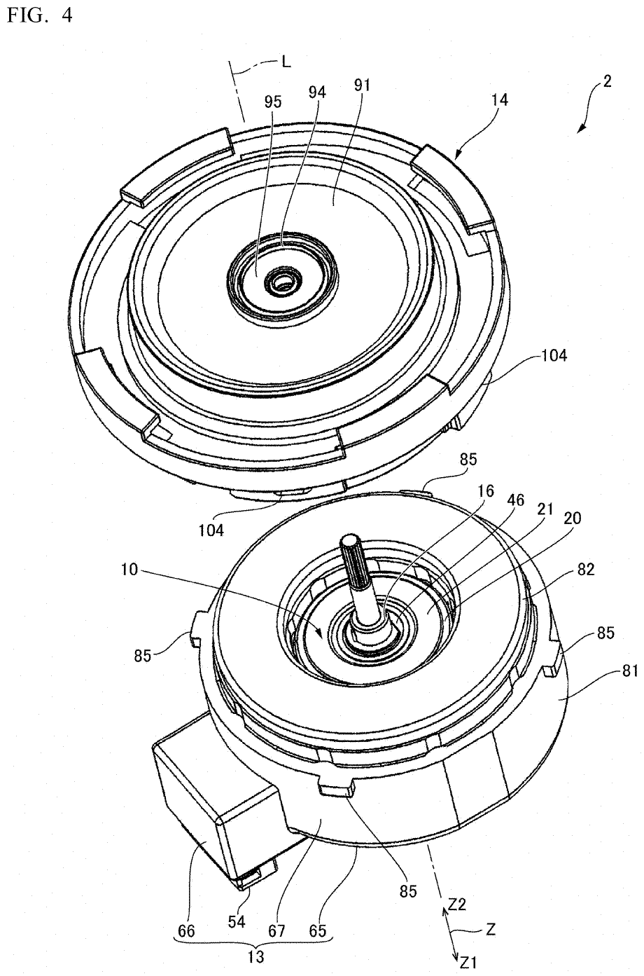

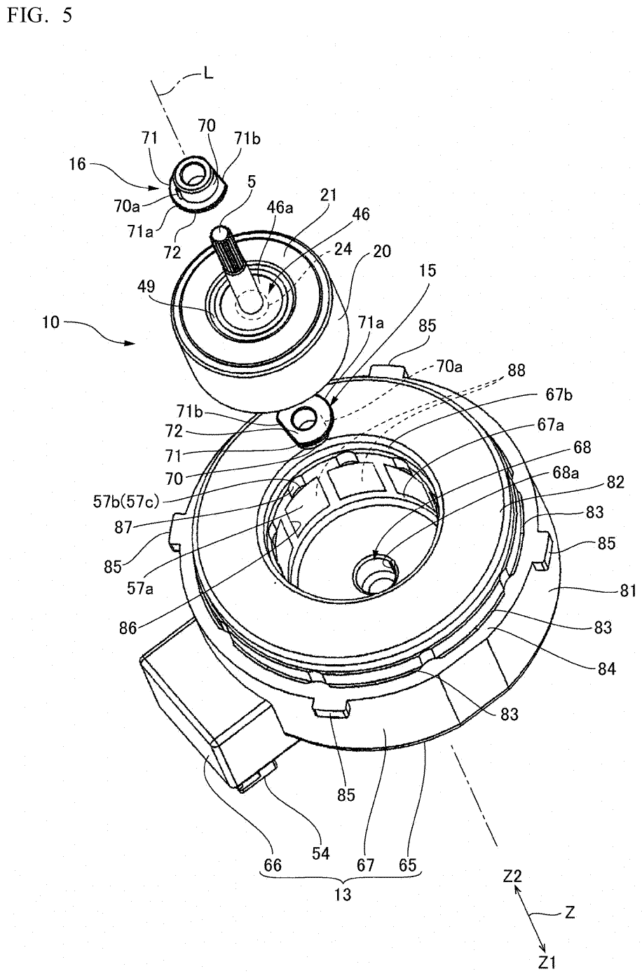

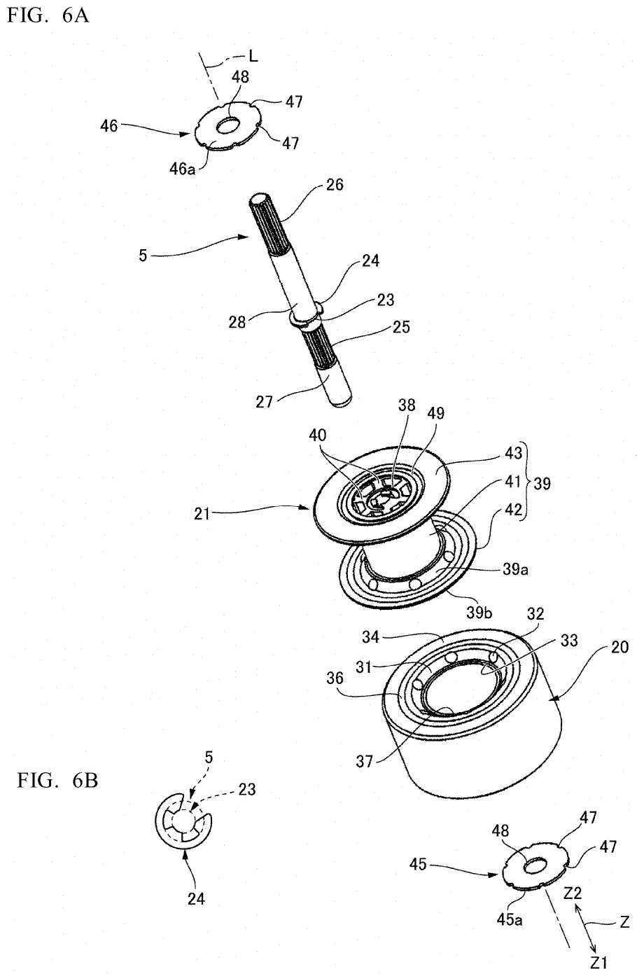

FIG. 4 is a perspective view of the motor 2, in a state where the cover member 14 is removed. FIG. 5 is an exploded perspective view of the motor 2, in a state where the cover member 14 is removed. FIG. 6A is an exploded perspective view of the rotor 10, and FIG. 6B is an explanatory drawing of fixing construction of a stop ring to the rotating shaft 5. As shown in FIG. 4 through FIG. 8, the rotor 10 is provided with the rotating shaft 5, a magnet 20 that surrounds the rotating shaft 5, and a holding member 21 that holds the rotating shaft 5 and the magnet 20.

The rotating shaft 5 is made of stainless steel. As FIG. 6A shows, the rotating shaft 5 is provided with an annular groove 23 at a position placed slightly lower than a center in a vertical direction. To the annular groove 23, a stop ring 24 (a metal component) is fixed. The stop ring 24 is a plate-like component, made of steel. As shown in FIG. 6B, the stop ring 24 is fixed to the annular groove 23 of the rotating shaft 5, so as to protrude to an outer circumferential side from the rotating shaft 5. The rotating shaft 5 is provided with a first knurled part 25 having a predetermined length, at a lower side of the annular groove 23. Moreover, the rotating shaft 5 is provided with a second knurled part 26 having a predetermined length, from a top end part in a downward direction. The second knurled part 26 is a part that protrudes upward from the housing 12 of the motor 2, so as to reach an inner part of the pumping chamber 4, and the second knurled part 26 is a part to which the impeller 6 is mounted. At a lower side of the first knurled part 25 in the rotating shaft 5, there is provided a first supported part 27 to be supported by the first bearing component 15. Between the annular groove 23 and the second knurled part 26 in the rotating shaft, there is provided a second supported part 28 to be supported by the second bearing component 16.

Being annular, the magnet 20 is so placed as to be coaxial with the rotating shaft 5. The magnet 20 is placed at an outer circumferential side of the first knurled part 25. In an outer circumferential surface of the magnet 20, there are magnetized an N-pole and an S-pole, alternately in a circumferential direction.

As shown in FIG. 6A and FIG. 6B, at an edge part in an inner circumferential side of a top surface of the magnet 20, there exist a taper surface 31 and an annular surface 33 that are continuously provided side by side; the taper surface 31 being tapered in a downward direction toward an inner circumferential side, while the annular surface 33 extending from a bottom end of the taper surface 31 to an inner circumferential side. Moreover, also at an edge part in an inner circumferential side of a bottom surface of the magnet 20, in the same manner as in the inner circumferential side of the top surface of the magnet 20; there exist another taper surface 31 and another annular surface 33 that are continuously provided side by side; the taper surface 31 being tapered in an upward direction toward an inner circumferential side, while the annular surface 33 extending from a top end of the taper surface 31 to an inner circumferential side. In the taper surface 31 of both the top surface and the bottom surface, there are shaped a plurality of concave parts 32 at regular angular intervals, in a circumferential direction. Each inner circumferential surface of the plurality of concave parts 32 is provided with a spherical form.

In the top surface of the magnet 20, there is prepared an annular surface 34 that is perpendicular to the axis line L, at an outer circumferential side from the taper surface 31. In the annular surface 34, there is provided an annular groove 36 that has a constant width, and extends in a circumferential direction. A cross-sectional view in a radial direction of the annular groove 36 has a circular form. The annular groove 36 is placed at a slightly-inner position in comparison to a center of the annular surface 34. Also, in another annular surface 34 placed at an outer circumferential side from the taper surface 31, in the bottom surface of the magnet 20; in the same manner as in the top surface of the magnet 20, there is provided another annular groove 36 that has a constant width, and extends in a circumferential direction. A cross-sectional view in a radial direction of the annular groove 36, provided in the bottom surface, has a circular form. The annular groove 36, provided in the bottom surface, is placed at a slightly-inner position in comparison to a center of the annular surface 34.

The holding member 21 is a resin-molded component that holds a part, including the first knurled part 25 of the rotating shaft 5, from an outer circumferential side. The holding member 21 includes: a rotating shaft holding part 38 being cylindrical; a magnet holding part 39, being annular, for holding the magnet 20 at an outer circumferential side of the rotating shaft holding part 38; and a plurality of connection parts 40, radially extending in a radial direction from the rotating shaft holding part 38, for connection between the rotating shaft holding part 38 and the magnet holding part 39.

The magnet holding part 39 includes: a magnet holding sleeve 41 to cover an inner circumferential surface 37 of the magnet 20 from an inner circumferential side; a first magnet holding flange 42, being annular and extending outward from a bottom end part of the magnet holding sleeve 41; and a second magnet holding flange 43, being annular and extending outward from a top end part of the magnet holding sleeve 41. The first magnet holding flange 42 covers a part of a bottom surface of the magnet 20, excluding an outer circumferential edge part of the bottom surface. In other words, the first magnet holding flange 42 covers the bottom surface of the magnet 20, up to an outer circumferential side of the annular groove 36. The second magnet holding flange 43 covers a part of a top surface of the magnet 20, excluding an outer circumferential edge part of the top surface. In other words, the second magnet holding flange 43 covers the top surface of the magnet 20, up to an outer circumferential side of the annular groove 36.

The first magnet holding flange 42 and the second magnet holding flange 43 individually include a taper surface covering part 39a that covers the taper surface 31, and an annular plate part 39b, placed at an outer circumferential side of the taper surface covering part 39a, which overlaps with the annular surface 34. Being compared to the annular plate part 39b, the taper surface covering part 39a is thicker in a vertical direction. Incidentally, the first magnet holding flange 42 and the second magnet holding flange 43 are shaped along the top surface and the bottom surface of the magnet 20, respectively; in such a way as to closely adhere to the inner circumferential surface of the concave parts 32 and an inner circumferential surface of the annular groove 36.

The number of the connection parts 40 is the same as the number of the concave parts 32 of the magnet 20. The holding member 21 holds the magnet 20, in such a way that each of the concave parts 32 of the magnet 20 is placed at an outer side in a radial direction of each of the connection parts 40. A bottom surface of the connection parts 40 is perpendicular to the axis line L. Moreover, as shown in FIG. 1, the stop ring 24 fixed to the rotating shaft 5 is held in a state where a part, protruding from the rotating shaft 5 to an outer circumferential side, is embedded in an upper surface of the rotating shaft holding part 38. In the stop ring 24, a top surface of the part protruding from the rotating shaft 5 to the outer circumferential side is exposed upward from the rotating shaft holding part 38. An upper surface of the stop ring 24, the upper surface of the rotating shaft holding part 38, and an upper surface of the connection parts 40 are positioned in one plane being perpendicular to the axis line L.

Then, the rotor 10 is provided with a first bearing plate 45 held at a bottom end side of the holding member 21, and a second bearing plate 46 (a second metal component) held at a top end side of the holding member 21. The first bearing plate 45 and the second bearing plate 46 are individually a metal plate being annular. The first bearing plate 45 and the second bearing plate 46 are provided with a plurality of cutout parts 47 at an outer circumferential edge. Therefore, the first bearing plate 45 and the second bearing plate 46 are so prepared as to have a convex-concave part at the outer circumferential edge.

The cutout parts 47 are shaped at six locations at regular angular intervals. Each of the cutout parts 47, shaped in the first bearing plate 45 and the second bearing plate 46, faces each of the connection parts 40 in a vertical direction. The first bearing plate 45 is fixed to the holding member 21, in a state where the rotating shaft 5 is inserted through a center hole 48 of the first bearing plate 45, in such a way as to cover the connection parts 40 and the rotating shaft holding part 38 from the bottom end side of the holding member 21. As shown in FIG. 1, in the state where the first bearing plate 45 is fixed to the holding member 21, a lower surface of the first bearing plate 45 is perpendicular to the axis line L. The second bearing plate 46 is fixed to the holding member 21, in a state where the rotating shaft 5 is inserted through a center hole 48 of the second bearing plate 46, in such a way as to cover the connection parts 40, the rotating shaft holding part 38, and the stop ring 24 from an upper side of the holding member 21. In the state where the second bearing plate 46 is fixed to the holding member 21, the second bearing plate 46 and the stop ring 24 contact each other with their faces fully contacting. An upper surface of the second bearing plate 46 is perpendicular to the axis line L. The upper surface of the second bearing plate 46 is a rotor side sliding surface 46a that sliding-contacts on the second bearing component 16 from a lower side.

Incidentally, shaping the holding member 21 is carried out by means of insert-molding in which the rotating shaft 5, equipped with the stop ring 24, and the magnet 20 are placed inside a mold, and then a resin material is injected. The first bearing plate 45 and the first bearing plate 45 are held by the holding member 21 after the insert-molding.

At a time of having the holding member 21 hold the first bearing plate 45, the rotating shaft 5 is inserted through the center hole 48 of the first bearing plate 45, and the first bearing plate 45 is placed over the connection parts 40 at the bottom end side of the holding member 21 and the rotating shaft holding part 38 at the bottom end side. Subsequently, a part of the holding member 21, located at an outer circumferential side of the first bearing plate 45, is plastically deformed by means of heat, in order to cover an outer circumferential part of the lower surface of the first bearing plate 45, and furthermore to make the resin material enter each of the cutout parts 47. Thus, there is provided a plastically-deformed part 49, being annular, which covers an outer circumferential edge of the first bearing plate 45 from a lower side and the outer circumferential side, at a lower surface of the holding member 21. The first bearing plate 45 is held by use of the connection parts 40 at the bottom end side (contacting part) and the rotating shaft holding part 38 at the bottom end side (contacting part) of the holding member 21, as well as the plastically-deformed part 49. In the same way, at a time of having the holding member 21 hold the second bearing plate 46, the rotating shaft 5 is inserted through the center hole 48 of the second bearing plate 46, and the second bearing plate 46 is placed over the connection parts 40 at the top end side of the holding member 21 and the rotating shaft holding part 38 at the top end side; and then, a lower surface of the second bearing plate 46 is made to contact the upper surface of the stop ring 24, with their faces fully contacting. Subsequently, a part of the holding member 21, located at an outer circumferential side of the second bearing plate 46, is plastically deformed by means of heat, in order to cover an outer circumferential part of the upper surface of the second bearing plate 46, and furthermore to make the resin material enter each of the cutout parts 47. Thus, there is formed a plastically-deformed part 49, being annular, which covers an outer circumferential edge of the second bearing plate 46 from an upper side and the outer circumferential side, at an upper surface of the holding member 21. The second bearing plate 46 is held by use of the connection parts 40 at the top end side (contacting part) and the rotating shaft holding part 38 at the top end side (contacting part) of the holding member 21, as well as the upper surface of the stop ring 24, and the plastically-deformed part 49.

### Stator

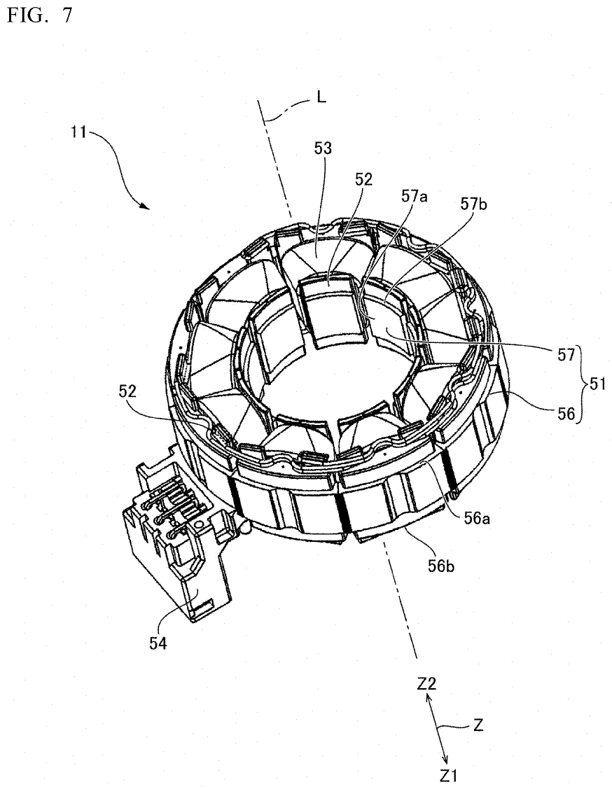

FIG. 7 is a perspective view of the stator 11. The stator 11 includes: a stator core 51, being annular, which is placed at an outer circumferential side of the rotor 10; a plurality of coils 53 wound around the stator core 51 by the intermediary of an insulator 52; and a connector 54 for connecting a power supply cable in order to supply each of the coils 53 with electric power.

The stator core 51 is a laminated core formed by way of laminating a thin magnetic plate made of a magnetic material. As shown in FIG. 7, the stator core 51 includes an annular part 56 and a plurality of salient core parts 57 protruding inward in a radial direction from the annular part 56. The plurality of salient core parts 57 are formed at regular angular intervals, in such a way as to be placed at regular intervals in a circumferential direction. In the present example, the plurality of salient core parts 57 are formed at angular intervals of 40 degrees, being centered around the axis line L. Therefore, the stator core 51 is provided with nine salient core parts 57. An inner circumferential end surface 57a of the salient core parts 57 is a circular surface, being centered around the around the axis line L; and the inner circumferential end surface 57a faces the outer circumferential surface of the magnet 20 of the rotor 10, across a small clearance.

Each insulator 52 is made of insulating material, such as resin and the like. Each insulator 52 is shaped so as to be flanged-tubular, having a flange part at each of both ends in a radial direction; and then the insulator 52 is fixed to each of the salient core parts 57 in such a way that an axial direction of the insulator 52, shaped to be tubular, is consistent with a radial direction of the stator 11. Each of the coils 53 is wound around each of the salient core parts 57, by the intermediary of the insulator 52. In a state of being wound around the insulator 52, each of the coils 53 vertically protrudes toward an outer side in a radial direction. Incidentally, although the insulator 52 partially covers an upper surface of the annular part 56 of the stator core 51, an outer circumferential edge part 56a of the upper surface of the annular part 56 is not covered by the insulator 52. In the same way, although the insulator 52 partially covers a lower surface of the annular part 56 of the stator core 51, an outer circumferential edge part 56b of the lower surface of the annular part 56 is not covered by the insulator 52.

A tip part of each of the salient core parts 57 protrudes toward an inner circumferential side from the insulator 52. In each of the salient core parts 57, a part being exposed toward the inner circumferential side from the insulator 52 (a part between the inner circumferential end surface 57a and a part where each of the coils 53 is wound) is provided with an axial-direction end surface 57b that is perpendicular to the axis line L. At one insulator 52 among a plurality of insulators 52, there is formed the connector 54, together with the insulator 52, to which a cable for supplying the coils 53 with electric power is connected in a detachable manner.

### Resin Sealing Member

As shown in FIG. 5, the resin sealing member 13 is provided with a sealing member bottom part 65, having a disc-like shape, which covers the coils 53, the insulators 52, and the stator core 51 from a lower side. Furthermore, the resin sealing member 13 includes a sealing member protrusion part 66 that extends toward an outer circumferential side from the sealing member bottom part 65, in such a way as to cover the connector 54, and a sealing member cylindrical part 67 that extends upward from the sealing member bottom part 65, in such a way as to cover the coils 53, the insulators 52, and the stator core 51.

At a center part in an upper surface of the sealing member bottom part 65, there is provided a bearing component holding concave part 68. At a position lower than the magnet 20 of the rotating shaft 5, the bearing component holding concave part 68 holds the first bearing component 15 that supports the rotor 10 so as to be rotatable. The bearing component holding concave part 68 is a circular concave part, which includes a groove 68a extending in a vertical direction, at a part in a circular direction, in an inner circumferential surface of the concave part.

Being made of resin, the first bearing component 15 includes: a supporting part 70, which is cylindrical and provided with a through-hole for making the rotating shaft 5 pass through; and a flange part 71 extending from an upper end of the supporting part 70 toward an outer circumferential side. At a part in a circular direction, in an outer circumferential surface of the supporting part 70, there is shaped a convex part 70a that extends with a certain width in a vertical direction. In a view from a vertical direction, a profile of the flange part 71 is shaped like a character ‘D’, including a circular profile part 71a with an arch form, and a linear profile part 71b that linearly connects one end and the other end in a circumferential direction of the circular profile part 71a. The linear profile part 71b is placed at a position opposite to the convex part 70a across the through-hole.

With respect to the first bearing component 15; in a state where positions of the convex part 70a of the supporting part 70 and the groove 68a of the bearing component holding concave part 68 are made to be consistent with each other, the supporting part 70 is inserted into the bearing component holding concave part 68. Then, as shown in FIG. 1; while having been inserted until the flange part 71 contacts the sealing member bottom part 65 from an upper side, the first bearing component 15 is fixed to the bearing component holding concave part 68. In the state where the first bearing component 15 is fixed to the bearing component holding concave part 68, an upper end surface of the flange part 71 is perpendicular to the axis line. In this situation, the supporting part 70 functions as a radial bearing unit for the rotating shaft 5, and meanwhile the flange part 71 functions as a thrust bearing unit for the rotor 10. In other words, the upper end surface of the flange part 71 is a sliding surface 72 that the rotor 10 sliding-contacts. The lower surface of the first bearing plate 45, which is fixed to the holding member 21 of the rotor 10, sliding-contacts the sliding surface 72 of the first bearing component 15. In other words, the lower surface of the first bearing plate 45 is a rotor side sliding surface 45a that sliding-contacts the sliding surface 72 of the first bearing component 15. Incidentally, grease is applied to the sliding surface 72.

Incidentally, as shown in FIG. 3; the sealing member bottom part 65 includes: a bearing support part 75, being cylindrical, which surrounds the first bearing component 15 from an outer circumferential side in a radial direction; a coil sealing part 76 positioned at a lower side of the coils 53; a connection part 77 for connection between the bearing support part 75 and the coil sealing part 76; and a blocking part 78, being circular, for blocking up a lower end opening part of the bearing support part 75 being cylindrical. The bearing support part 75 and the blocking part 78 constitute the bearing component holding concave part 68, and an inner circular surface of the bearing support part 75 is namely an inner circular surface of the bearing component holding concave part 68. A lower surface of the coil sealing part 76 is provided with a tapered surface part 76a, which is tilted downward in a direction to an outer circumferential side, along a form of each of the coils 53 wound around the insulator 52.

As shown in FIG. 1, a thickness ‘A’ of the connection part 77 in a direction of the axis line L is thinner than a thickness ‘B’ of the bearing support part 75 and a thickness ‘C’ of the coil sealing part 76. Moreover, a lower surface of the connection part 77 is placed at a location higher than a lower surface of the bearing support part 75 and a lower surface of the coil sealing part 76. Therefore, as shown in FIG. 3; at lower surface of the sealing member bottom part 65 (the resin sealing member 13), there is shaped a concave part 65a, being annular, whose bottom surface is a lower surface of the connection part 77. Furthermore, a lower surface of the bearing support part 75 and the blocking part 78 is placed at a location lower than lower surface of the coil sealing part 76. In other words, the bearing support part 75 and the blocking part 78, which hold the first bearing component 15, protrude further downward than the coil sealing part 76.

Then, as shown in FIG. 4 and FIG. 5, the sealing member cylindrical part 67 includes a large-diameter cylindrical part 81, and a small-diameter cylindrical part 82 having an outer diameter being smaller than the large-diameter cylindrical part 81 has; the large-diameter cylindrical part 81 and the small-diameter cylindrical part 82 being placed in this order from a lower side toward an upper side. As shown in FIG. 1, an outer diameter of the large-diameter cylindrical part 81 is greater than an outer diameter of the annular part 56 of the stator core 51, and meanwhile the outer diameter of the small-diameter cylindrical part 82 is smaller than the outer diameter of the annular part 56 of the stator core 51.

As shown in FIG. 5, there are provided a plurality of annular opening parts 83 for exposing upward an outer circumferential edge part 56a of the annular part 56 of the stator core 51, out of the resin sealing member 13, at a boundary part between the large-diameter cylindrical part 81 and the small-diameter cylindrical part 82 in the sealing member cylindrical part 67. Moreover, at an outer circumferential side of the annular opening parts 83 in the resin sealing member 13, there is provided an annular end surface 84, being perpendicular to the axis line L. The outer circumferential edge part of the stator core 51, being exposed from the annular opening parts 83, and the annular end surface 84 are positioned in one plane being perpendicular to the axis line L. At an upper end part of the large-diameter cylindrical part 81, there are provided four latching protrusion parts 85, protruding toward an outer circumferential side at regular angular intervals.

An inner circumferential surface of the sealing member cylindrical part 67 includes a small-diameter inner circumferential surface part 67a, and a large-diameter inner circumferential surface part 67b having an inner diameter that is greater than the small-diameter inner circumferential surface part 67a; the small-diameter inner circumferential surface part 67a and the large-diameter inner circumferential surface part 67b being placed in this order from a lower side toward an upper side. A radius of curvature of the small-diameter inner circumferential surface part 67a is almost the same as a radius of curvature of the inner circumferential end surface 57a of the salient core parts 57. In the small-diameter inner circumferential surface part 67a, there are provided a plurality of opening parts 86 for exposing the inner circumferential end surface 57a of each of the salient core parts 57 of the stator core 51, toward an inner circumferential side. Moreover, in the small-diameter inner circumferential surface part 67a, there is provided a cutout part 87 for exposing upward a part of the axial-direction end surface 57b of each of the salient core parts 57. In other words, in the small-diameter inner circumferential surface part 67a, there are formed nine cutout parts 87 at angular intervals of 40 degrees, being centered around the axis line L. Each of the cutout parts 87 is a groove extending from an edge of the opening parts 86 up to an upper end edge of the small-diameter inner circumferential surface part 67a. A cross-sectional form of the cutout parts 87 is an arch form. Owing to the plurality of cutout parts 87 being provided, a middle part in a circumferential direction at a top end part of the axial-direction end surface 57b of each of the salient core parts 57 becomes an exposed part 57c being exposed upward.

Being exposed out of the opening parts 86, the inner circumferential end surface 57a of each of the salient core parts 57 is continuous with the small-diameter inner circumferential surface part 67a, having no uneven level. A rust prevention agent 88 is applied to the inner circumferential end surface 57a of each of the salient core parts 57, being exposed out of the opening parts 86. Furthermore, the rust prevention agent 88 is also applied to the exposed part 75c of the axial-direction end surface 57b of each of the salient core parts 57 being exposed out of the cutout parts 87. In the present example, an epoxy coating material is used as the rust prevention agent 88. Incidentally, as the rust prevention agent 88, any other coating material other than the epoxy coating material, an anti-corrosive oil, or an adhesive may be used.

The resin sealing member 13 is made of a bulk molding compound (BMC). In the present embodiment, the resin sealing member 13 is made in such a way that the stator 11 is placed inside a mold, and a resin material is injected into the mold, and then hardened there. In other words, the resin sealing member 13 is formed together with the stator 11, by means of insert-molding.

Incidentally, according to the present embodiment; the inner circumferential end surface 57a of each of the salient core parts 57 of the stator core 51 is exposed out of the resin sealing member 13. Therefore, in a course of the insert-molding; there is provided a columnar-shaped mold piece in the mold, and an outer circumferential surface of the mold piece is made to contact the inner circumferential end surface 57a of each of the salient core parts 57, in such a way that the stator core 51 can be aligned with a right position in a radial direction. Moreover, the resin sealing member 13 exposes upward a part of the axial-direction end surface 57b of each of the salient core parts 57 of the stator core 51 (i.e., the exposed part 57c). Furthermore, the resin sealing member 13 exposes upward the outer circumferential edge part 56a of the annular part 56 of the stator core 51. Therefore, in the course of the insert-molding; in the mold, there is provided a first contacting part that is able to contact the axial-direction end surface 57b of each of the salient core parts 57 from an upper side, and a second contacting part that is able to contact the outer circumferential edge part of the annular part 56 from an upper side, and then the first contacting part and the second contacting part are made to contact the stator core 51, in such a way that the stator core 51 can be aligned with a right position in a direction of the axis line L. In other words, according to the present embodiment; the resin sealing member 13 can be formed by way of injecting the resin material into the mold, in a state where the stator core 51 placed in the mold is aligned with the right position in the radial direction and the direction of the axis line L. Therefore, an accuracy in relative positioning of the stator core 51 and the resin sealing member 13 is improved.

Incidentally, the cutout parts 87 provided in the inner circumferential surface of the sealing member cylindrical part 67 are traces of the first contacting part provided in the mold. In other words, in the course of the insert-molding, the first contacting part provided in the mold is made to contact the axial-direction end surface 57b of each of the salient core parts 57 in the direction of the axis line L; and therefore, at a time when the BMC has been solidified so as to form the resin sealing member 13, a part that the first contacting part has contacted consequently becomes the exposed part 57c, and the part that the first contacting part has contacted is provided with the cutout parts 87.

### Cover Member

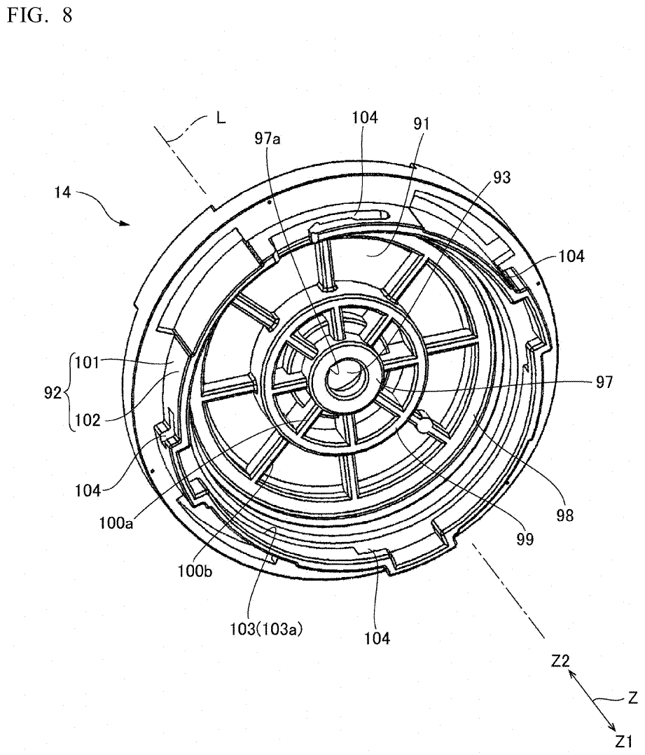

FIG. 8 is a perspective view, at a time of observing the cover member 14 from a lower side. The cover member 14 is made of a resin material, and fixed on the resin sealing member 13.

The cover member 14 includes a cover member ceiling part 91 being disc-shaped, and a cover member cylindrical part 92 that extends downward from the cover member ceiling part 91. The cover member ceiling part 91 has a through-hole 93, which vertically passes through, at a center position. As shown in FIG. 1 and FIG. 4, at a center part of the cover member ceiling part 91, there is provided a circular concave part 94 surrounding the through-hole 93. A sealing member 95, being annularly-shaped, is placed into the circular concave part 94.

As shown in FIG. 8, at a lower surface of the cover member ceiling part 91, there is provided a bearing component holding cylindrical part 97, being coaxial with the through-hole 93, at a center position. Moreover, the lower surface of the cover member ceiling part 91 is provided with an outer annular rib 98, being along an outer circumferential edge part being circular, of the cover member ceiling part 91. Furthermore, the lower surface of the cover member ceiling part 91 is provided with an inner annular rib 99, being circular, between the bearing component holding cylindrical part 97 and the outer annular rib 98. Then, between the bearing component holding cylindrical part 97 and the inner annular rib 99, there is provided an inner rib 100a radially stretching from the bearing component holding cylindrical part 97 so as to reach the inner annular rib 99. Meanwhile, between the inner annular rib 99 and the outer annular rib 98, there is provided an outer rib 100b radially stretching from the inner annular rib 99 so as to reach the outer annular rib 98. The bearing component holding cylindrical part 97, the outer annular rib 98, and the inner annular rib 99 are placed coaxially. A lower bottom surface of the bearing component holding cylindrical part 97, a lower bottom surface of the outer annular rib 98, and a lower bottom surface of the inner annular rib 99 are planes perpendicular to the axis line L. A protrusion amount of the bearing component holding cylindrical part 97 out of the lower surface of the cover member ceiling part 91 is greater than a protrusion amount of the inner annular rib 99 out of the lower surface of the cover member ceiling part 91. A protrusion amount of the inner annular rib 99 out of the lower surface of the cover member ceiling part 91 is greater than a protrusion amount of the outer annular rib 98 out of the lower surface of the cover member ceiling part 91. A lower surface of the outer rib 100b and the lower surface of the outer annular rib 98 are placed in one plane.

As shown in FIG. 8, the bearing component holding cylindrical part 97 includes a groove 97a that extends in a vertical direction at a part in a circumferential direction of an internal circumferential wall of a center hole. Furthermore, as shown in FIG. 1, in the center hole of the bearing component holding cylindrical part 97, there is held the second bearing component 16.

Incidentally, the second bearing component 16 is a component that is the same as the first bearing component 15 and placed upside down. Being made of resin, the second bearing component 16 includes: the supporting part 70, which is cylindrical and provided with the through-hole for making the rotating shaft 5 pass through; and the flange part 71 extending from a lower end of the supporting part 70 toward an outer circumferential side, as shown in FIG. 5. At a part in a circular direction, in an outer circumferential surface of the supporting part 70, there is shaped a convex part 70a that extends with a certain width in a vertical direction. In a view from a vertical direction, a profile of the flange part 71 is shaped like a character ‘D’, including a circular profile part 71a with an arch form, and a linear profile part 71b that linearly connects one end and the other end in a circumferential direction of the circular profile part 71a. The linear profile part 71b is placed at a position opposite to the convex part 70a across the through-hole.

With respect to the second bearing component 16; in a state where positions of the convex part 70a of the supporting part 70 and the groove 97a of the bearing component holding cylindrical part 97 are made to be consistent with each other, the supporting part 70 is inserted into the bearing component holding cylindrical part 97. Then, as shown in FIG. 1; while having been inserted until the flange part 71 contacts the cover member 14 (i.e., the cover member ceiling part 91 and a lower surface of the bearing component holding cylindrical part 97) from a lower side, the second bearing component 16 is fixed to the bearing component holding cylindrical part 97. In the state where the second bearing component 16 is fixed to the bearing component holding cylindrical part 97, an upper end surface of the flange part 71 is perpendicular to the axis line. In this situation, the supporting part 70 functions as a radial bearing unit for the rotating shaft 5, and meanwhile the flange part 71 functions as a thrust bearing unit for the rotor 10. In other words, the lower end surface of the flange part 71 is a sliding surface 72 that the rotor 10 sliding-contacts. The upper surface of the second bearing plate 46, which is fixed to the holding member 21 of the rotor 10, sliding-contacts the sliding surface 72 of the second bearing component 16. In other words, the upper surface of the second bearing plate 46 is a rotor side sliding surface 46a that sliding-contacts the sliding surface 72 of the second bearing component 16. Incidentally, grease is applied to the sliding surface 72.

As shown in FIG. 1, the cover member cylindrical part 92 extends downward from an outer circumferential side of the outer annular rib 98. The cover member cylindrical part 92 includes an upper side annular cylindrical part 101 to overlap with the small-diameter cylindrical part 82 of the resin sealing member 13 so as to cover the part from an outer circumferential part, and a lower side annular cylindrical part 102 placed at an outer circumferential side of the large-diameter cylindrical part 81 at a lower side of the upper side annular cylindrical part 101. As shown in FIG. 8, there is provided an annular step part 103 between the upper side annular cylindrical part 101 and the lower side annular cylindrical part 102, in an inner circumferential surface of the cover member cylindrical part 92. The annular step part 103 includes an annular surface 103a facing downward. The annular surface 103 a is a plane perpendicular to the axis line L. In the lower side annular cylindrical part 102, there are provided catching parts 104, which engage with the latching protrusion parts 85 of the resin sealing member 13, at four locations in a circumferential direction.

Then, the cover member 14 is placed onto the resin sealing member 13 to cover the member from an upper direction; in a state where the rotor 10 is placed inside the resin sealing member 13, and the rotor 10 is supported by the first bearing component 15. At a time when the cover member 14 is placed onto the resin sealing member 13 to cover the member, an adhesive is applied to an outer circumferential edge part of an upper surface of the resin sealing member 13.

At the time when the cover member 14 is placed onto the resin sealing member 13 to cover the member, a lower bottom part of the inner annular rib 99 is fit into an inner circumferential side of the sealing member cylindrical part 67 of the resin sealing member 13, as shown in FIG. 1. Accordingly, the cover member 14 and the resin sealing member 13 are aligned in a radial direction so that the axis line L of the rotating shaft 5 and a center axis line of the stator 11 become consistent with each other. Then, the annular surface 103a of the annular step part 103 of the cover member cylindrical part 92 is made to contact the annular end surface 84 between the large-diameter cylindrical part 81 and the small-diameter cylindrical part 82 in the resin sealing member 13. Accordingly, the cover member 14 and the resin sealing member 13 are aligned in the direction of the axis line L. Subsequently, the cover member 14 and the resin sealing member 13 are relatively turned in a circumferential direction, in such a way as that the latching protrusion parts 85 of the resin sealing member 13 and the catching parts 104 of the cover member 14 are engaged with each other, as shown in FIG. 3. Thus, the cover member ceiling part 91 covers the rotor 10 and the resin sealing member 13 from an upper side, while making the rotating shaft 5 pass through the cover member ceiling part 91. In the meantime, the sealing member 95, which is placed in the circular concave part 94 of the cover member ceiling part 91, seals a gap between the rotating shaft 5 and the cover member 14 as well as the second bearing component 16. Moreover, the upper side annular cylindrical part 101 of the cover member cylindrical part 92 surrounds the small-diameter cylindrical part 82 of the resin sealing member 13, from an outer circumferential side.

In this situation, the case body 3 is placed onto the cover member 14 to cover the member, from an upper side. Accordingly, a space partitioned between the cover member 14 and the case body 3 becomes the pumping chamber 4. The suction port 7 is provided in the case body 3 at a location that overlaps with the axis line L of the rotating shaft 5 of the motor 2. The discharge port 8 is provided at an outer side in a radial direction of the rotating shaft 5. When the impeller 6 is turned by way of a drive operation of the motor 2, a fluid is sucked from the suction port 7 and discharged out of the discharge port 8.

### Operation and Effect

In the present example, the holding member 21 made of a resin material, which holds the rotating shaft 5 from an outer circumferential side, holds the stop ring 24 that is fixed to the rotating shaft 5 so as to protrude from the rotating shaft 5 toward an outer circumferential side. Therefore, even in the case where heat is generated due to a slide motion between the second bearing component 16 and the rotor 10, it is possible to prevent or restrain a position of the holding member 21 from changing in relation to the rotating shaft 5 in a vertical direction (a direction of the axis line L), because the stop ring 24 is fixed to the rotating shaft 5. Accordingly, it is possible to prevent or restrain the magnet 20, held by the holding member 21, from changing its position in the vertical direction so that the rotation accuracy of the rotor 10 can be maintained. Moreover, since the holding member 21 holds the stop ring 24 being fixed to the rotating shaft 5, the heat generated due to the slide motion between the second bearing component 16 and the rotor 10 can be released to a side of the rotating shaft 5 by the intermediary of the stop ring 24. Therefore, it is possible to prevent or restrain the holding member 21, made of resin, from getting deformed owing to the heat generated due to the slide motion between the second bearing component 16 and the rotor 10.

Furthermore, in the present example, the rotating shaft 5 is made of metal. Therefore, the heat generated due to the slide motion between the rotor 10 and the second bearing component 16 is easily released by the intermediary of the rotating shaft 5.

Then, the rotating shaft 5 is provided with the annular groove 23, and therefore it is easy to fix the stop ring 24 to the rotating shaft 5 so as to protrude from the rotating shaft 5 toward an outer circumferential side.

Moreover, in the present example, the rotor 10 is provided with the second bearing plate 46 (the second metal component), made of metal, which is held by the holding member 21; and the second bearing plate 46 includes the rotor side sliding surface 46a that sliding-contacts the sliding surface 72 of the second bearing component 16. Thus, since the part that slides against the second bearing component 16 is made of metal in the rotor 10, the part is free from deformation owing to heat generated due to the slide motion. Moreover, the stop ring 24 fixed to the rotating shaft 5 contacts the second bearing plate 46, from a side opposite to the sliding surface 72. Therefore, even in the case where a force, biasing the rotor 10 toward a side of the second bearing component 16, acts at a time when the rotor 10 rotates so as to press the second bearing plate 46 against the second bearing component 16, the second bearing plate 46 does not change its position so as to move away from the sliding surface 72 in the vertical direction, and it is possible to prevent the rotor 10 from changing its position in the vertical direction.

Furthermore, the stop ring 24 contacts the second bearing plate 46, and therefore the heat generated due to the slide motion between the second bearing component 16 and the rotor 10 can be released from the second bearing plate 46 to the side of the rotating shaft 5 by the intermediary of the stop ring 24.

Moreover, the second bearing plate 46 is held by the holding member 21, in a state where the rotating shaft 5 is inserted through the center hole 48 of the second bearing plate 46, and the second bearing plate 46 is not fixed to the rotating shaft 5. Therefore, it is possible to avoid deformation of the second bearing plate 46 to be caused by way of fixing to the rotating shaft 5. Thus, a flatness of the rotor side sliding surface 46a can be maintained in such a way that it becomes easy to obtain the rotation accuracy of the rotor 10.

Furthermore, the second bearing plate 46 is held by use of the connection parts 40 at the top end side (contacting part) and the rotating shaft holding part 38 at the top end side (contacting part) of the holding member 21, as well as the upper surface of the stop ring 24, and the plastically-deformed part 49. Therefore, it is easy to hold the second bearing plate 46 by the holding member 21. Still further, the second bearing plate 46 includes the cutout parts 47 at the outer circumferential edge. Accordingly, it is possible to provide the holding member 21, made of a resin material, with the plastically-deformed part 49 deformed by heat, in such a way as to make the resin material, being deformed, enter the cutout parts 47 at the time of holding the second bearing plate 46. Thus, the second bearing plate 46 can surely be held by the holding member 21.

Then, in the case of the pump device 1 of the present example; since the impeller 6 is fixed to the rotating shaft 5 of the motor 2, a force biasing in a line direction of the rotating shaft 5 toward a side of the impeller 6 acts on the rotor 10, at a time when the rotor 10 rotates (when the impeller 6 fixed to the rotating shaft 5 rotates). Therefore, heat due to the slide motion is likely to be generated between the second bearing component 16, which orients the sliding surface 72 toward a side opposite to the impeller 6, and the rotor 10, so that there is a risk that the holding member 21, made of resin, gets deformed owing to the heat generated, and the rotor 10 changes its position in the vertical direction. Meanwhile, in the motor 2; the second bearing component 16, placed at a side of the impeller 6, orients the sliding surface 72 against the rotor 10 toward a side opposite to the impeller 6. Moreover, in the rotor 10; the holding member 21 made of resin, which holds the rotating shaft 5 from the outer circumferential side, holds the stop ring 24 that is fixed to the rotating shaft 5 so as to protrude from the rotating shaft 5 toward the outer circumferential side. Therefore, even in the case where the holding member 21 gets deformed owing to the heat generated due to the slide motion between the second bearing component 16 and the rotor 10, it is possible to prevent or restrain a position of the holding member 21 from changing in relation to the rotating shaft 5 in the vertical direction. Accordingly, it is possible to prevent or restrain the magnet 20, held by the holding member 21, from changing its position in the vertical direction so that the rotation accuracy of the rotor 10 can be maintained. Then, the rotation accuracy of the impeller 6 can be maintained. Moreover, since the holding member 21 holds the stop ring 24 being fixed to the rotating shaft 5, the heat generated due to the slide motion between the second bearing component 16 and the rotor 10 can be released to a side of the rotating shaft 5 by the intermediary of the stop ring 24. Therefore, it is possible to prevent or restrain the holding member 21, made of resin, from getting deformed owing to the heat generated due to the slide motion between the second bearing component 16 and the rotor 10.

### Other Embodiments

Although in the example described above; the rotating shaft 5 is provided with the annular groove 23 in order to support the first bearing plate 45, the rotating shaft 5 may be provided with a step part, which supports the first bearing plate 45.

Furthermore, although in the example described above; the second bearing plate 46, made of metal, is held by the holding member 21, the second bearing plate 46 may be omitted, and a washer may be placed between the holding member 21 and the second bearing component 16.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor comprising a rotating shaft; and
a bearing component structured to rotatably support;
wherein the bearing component comprises a sliding surface that the rotor sliding-contacts from a first side in an axial direction; and
the rotor comprises:
a holding member structured to hold the rotating shaft from an outer circumferential side;
a magnet held by the holding member; and
a metal component fixed to the rotating shaft and held by the holding member so as to protrude to the outer circumferential side from the rotating shaft.

2. The motor according to claim 1;
wherein the rotating shaft is made of metal.

3. The motor according to claim 1;
wherein the rotating shaft comprises an annular groove, and the metal component is a stop ring fixed to the annular groove.

4. The motor according to claim 1;
wherein the rotor comprises a second metal component held by the holding member,
the second metal component comprises a rotor side sliding surface that sliding-contacts the sliding surface, and
the metal component contacts the second metal component from a side opposite to the sliding surface in the axial direction.

5. The motor according to claim 4;
wherein the second metal component is an annular component through which the rotating shaft passes; and
the holding member comprises:
a contacting part that contacts the second metal component from the side opposite to the sliding surface in the axial direction, and
a plastically-deformed part that covers an outer circumferential edge of the second metal component from a side of the sliding surface and an outer circumferential side.

6. The motor according to claim 5;
wherein, the second metal component comprises a cutout part at an outer circumferential edge.

7. A pump device comprising:
a motor comprising:
a rotor comprising a rotating shaft; and
a bearing component structured to rotatably support;
wherein the bearing component comprises a sliding surface that the rotor sliding-contacts from a first side in an axial direction; and
the rotor comprises:
a holding member structured to hold the rotating shaft from an outer circumferential side;
a magnet held by the holding member; and
a metal component fixed to the rotating shaft and held by the holding member so as to protrude to the outer circumferential side from the rotating shaft; and
an impeller fixed to the rotating shaft;
wherein the bearing component orients the sliding surface toward a side opposite to the impeller.

8. The motor according to claim 2;
wherein the rotating shaft comprises an annular groove, and
the metal component is a stop ring fixed to the annular groove.

9. The motor according to claim 8;
wherein the rotor comprises a second metal component held by the holding member,
the second metal component comprises a rotor side sliding surface that sliding-contacts the sliding surface, and
the metal component contacts the second metal component from a side opposite to the sliding surface in the axial direction.

10. The motor according to claim 9;
wherein the second metal component is an annular component through which the rotating shaft passes; and
the holding member comprises:
a contacting part that contacts the second metal component from the side opposite to the sliding surface in the axial direction, and
a plastically-deformed part that covers an outer circumferential edge of the second metal component from a side of the sliding surface and an outer circumferential side.
